(19) United States
(12) Patent Application Publication
(10) Pub. No.: US 2019/0050819 A1
(43) Pub. Date: Feb. 14, 2019

(54) Electronic Calendar Assembly

(71) Applicant: Julie Nigro, N Andover, MA (US)

(72) Inventor: Julie Nigro, N Andover, MA (US)

(21) Appl. No.: 15/672,805

(22) Filed: Aug. 9, 2017

(51) Int. Cl. G06Q 10/10; G06F 3/0488; G06F 3/0484

(52) U.S. Cl. CPC G06Q 10/1095; G06F 3/04817; G06F 3/04847; G06F 3/04886

(57) ABSTRACT

An electronic calendar assembly includes a panel that is coupled to a vertical support surface thereby facilitating the panel to be observed. The panel has a height of at least 38.0 cm and a width of at least 30.0 cm such that the panel is visible from a distance. A display unit is coupled to the panel the display unit selectively displays indicia. The indicia comprise a monthly calendar including days of week, a name of the month and a grid for each day of the month. Each of the grids selectively displays indicia corresponding to events occurring on each day of the month. Moreover, the display unit is programmable to display selected indicia corresponding to the events. The display unit is in electrical communication with an extrinsic communication network thereby facilitating the events to be shared among selected people.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to calendar devices and more particularly pertains to a new calendar device for selectively displaying an electronic calendar.

### BRIEF SUMMARY OF THE INVENTION

An embodiment of the disclosure meets the needs presented above by generally comprising a panel that is coupled to a vertical support surface thereby facilitating the panel to be observed. The panel has a height of at least 38.0 cm and a width of at least 30.0 cm such that the panel is visible from a distance. A display unit is coupled to the panel the display unit selectively displays indicia. The indicia comprise a monthly calendar including days of week, a name of the month and a grid for each day of the month. Each of the grids selectively displays indicia corresponding to events occurring on each day of the month. Moreover, the display unit is programmable to display selected indicia corresponding to the events. The display unit is in electrical communication with an extrinsic communication network thereby facilitating the events to be shared among selected people.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an electronic calendar assembly according to an embodiment of the disclosure.

FIG. 2 is a front view of an embodiment of the disclosure.

FIG. 3 is a front perspective view of an embodiment of the disclosure.

FIG. 4 is a schematic view of an embodiment of the disclosure.

### DETAILED DESCRIPTION OF THE INVENTION

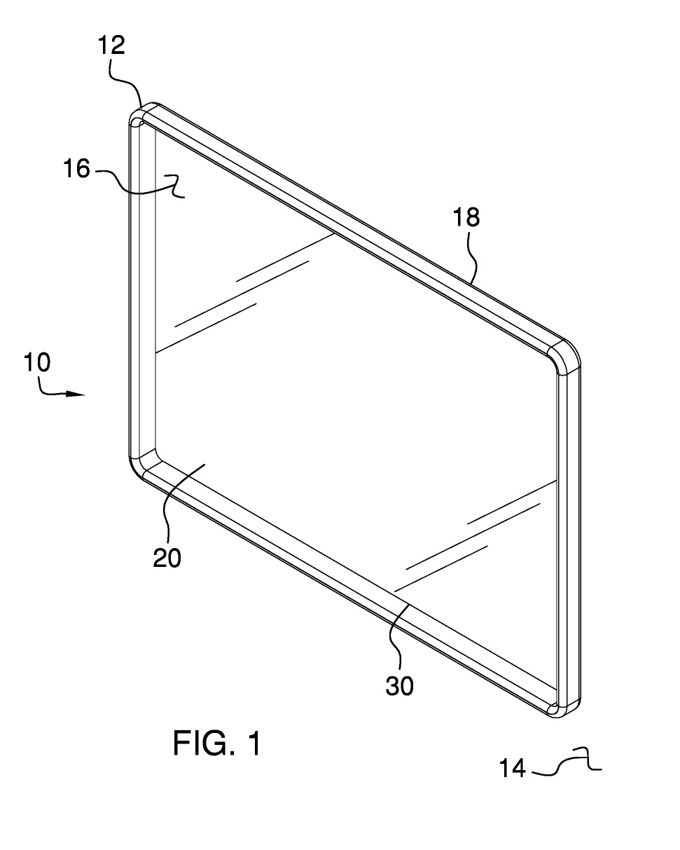

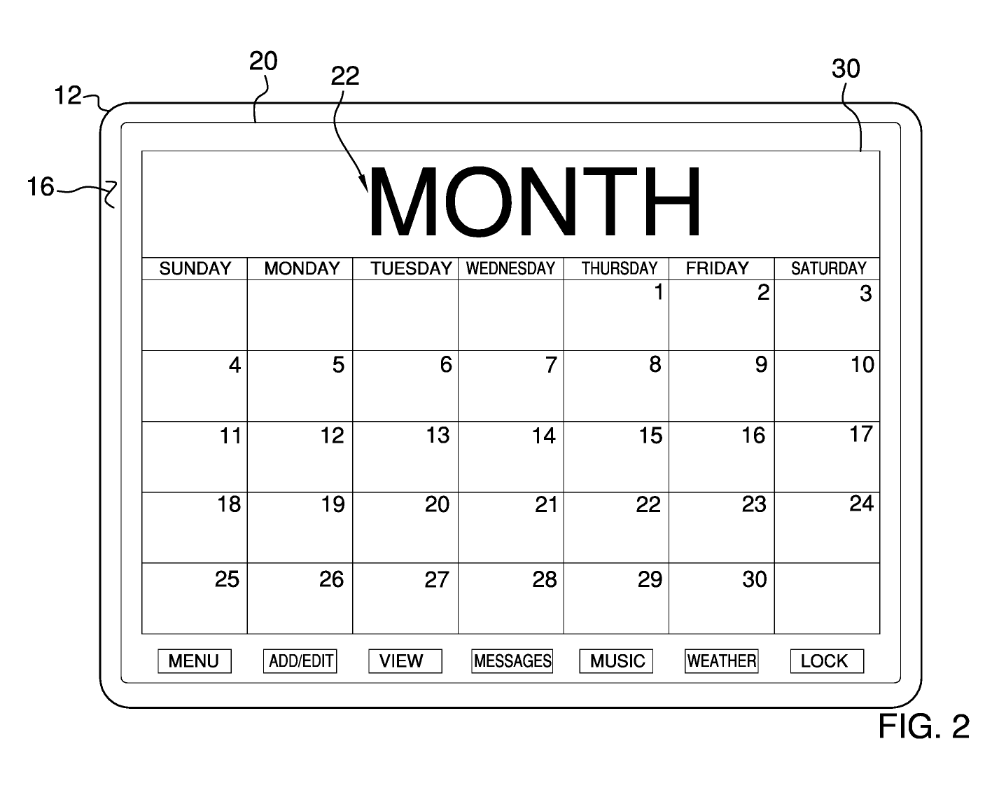

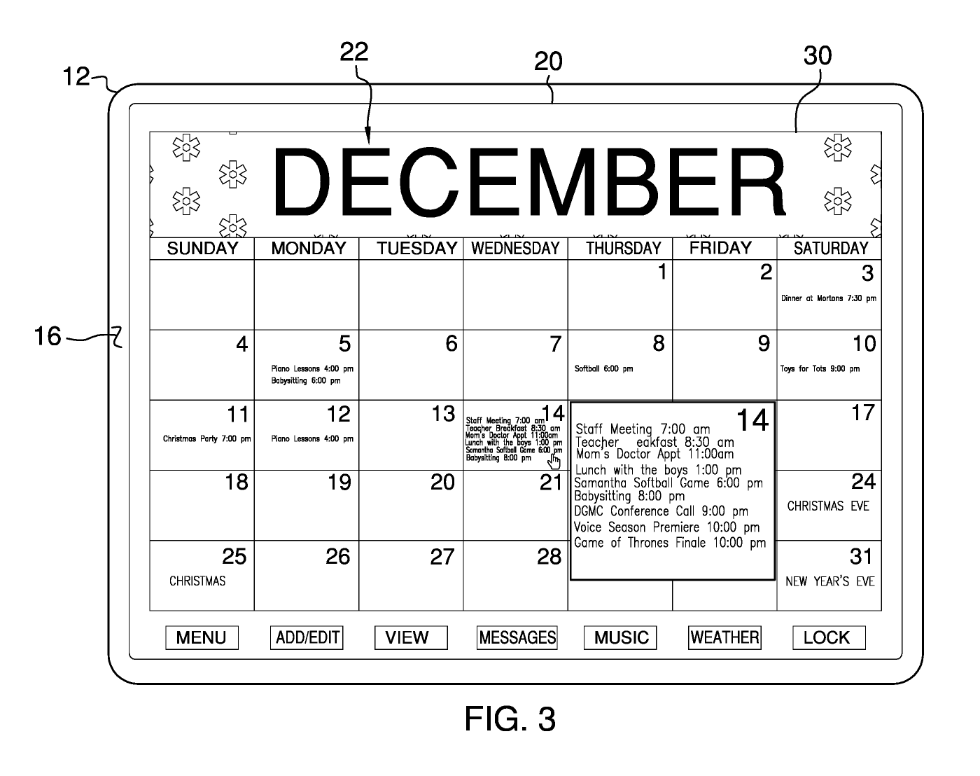

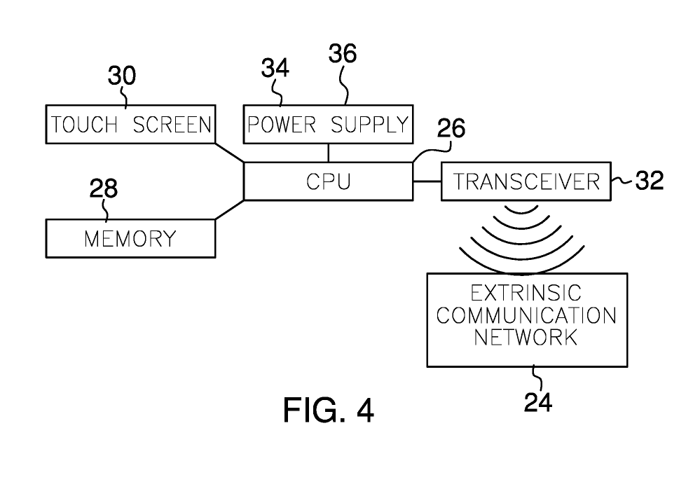

With reference now to the drawings, and in particular to FIGS. 1 through 4 thereof, a new calendar device embodying the principles and concepts of an embodiment of the disclosure and generally designated by the reference numeral 10 will be described.

As best illustrated in FIGS. 1 through 4, the electronic calendar assembly 10 generally comprises a panel 12 that may coupled to a vertical support surface 14, such as a wall or the like, thereby facilitating the panel 12 to be observed. The panel 12 has a first surface 16 and a second surface 18, and the second surface 18 is coupled to the vertical support surface 14. Moreover, the panel 12 has a height of at least 38.0 cm and a width of at least 30.0 cm such that the panel 12 is visible from a distance. The first surface 16 of the panel 12 may have a recess extending toward the second surface 18.

A display unit 20 is coupled to the panel 12 such that the display unit 20 is visible. The display unit 20 selectively displays indicia 22 that comprise a monthly calendar, including days of week, a name of the month and a grid for each day of the month. Each of the grids selectively displays indicia 22 corresponding to events occurring on each day of the month. The events may be appointments, birthdays, meetings and any other annual and prescheduled events. The display unit 20 is programmable to display selected indicia 22 corresponding to the events, such as the time of day the event occurs and details about the event. The display unit 20 is in electrical communication with an extrinsic communication network 24, such as the internet or the like, thereby facilitating the events to be shared among selected people.

The display unit 20 comprises a processor 26 that is positioned within the panel 12 and an electronic memory 28 that is positioned within the panel 12. The electronic memory 28 is electrically coupled to the processor 26 and the electronic memory 28 stores data pertaining to the monthly calendar and the events. The processor 26 may be an electronic processor 26 or the like and the electronic memory 28 may be RAM, a HDD and any other means of electronic data storage.

A touch screen 30 is coupled to the first surface 16 of the panel 12 and the touch screen 30 is selectively manipulated. The touch screen 30 may be positioned in the recess. The touch screen 30 is electrically coupled the processor 26 to control operational parameters of the processor 26 and facilitating data corresponding to the events to be entered into the electronic memory 28. Moreover, the touch screen 30 displays the indicia 22 and the touch screen 30 may be a touch sensitive LED or the like. The touch screen 30 may display a plurality of icons to control the operational parameters of the processor 26. The plurality of icons may include a menu icon, an add/edit icon, a view icon, a messages icon, a music icon, a weather icon and a lock icon. Additionally, each of the grids may be selectively enlarged to enhance viewing the events for a selected day.

A transceiver 32 is provided and the transceiver 32 is positioned within the panel 12. The transceiver 32 is electrically coupled to the processor 26 and the transceiver 32 is in wireless electrical communication with the extrinsic communication network 24. In this way the data corresponding to the events may be shared on the extrinsic communication network 24. The transceiver 32 may comprise a radio frequency transceiver 32 or the like. Selected apps and other downloadable content may be downloaded into the electronic memory 28 to enhance the monthly calendar.

A power supply 34 is coupled to the panel 12 and the power supply 34 is electrically coupled to the processor 26. The power supply 34 comprises at least one battery 36. A battery cover may removably coupled to the second surface 18 of the panel 12. The power supply 34 may be removably positioned beneath the battery cover.

In use, the panel 12 is mounted to the vertical support surface 14 through any selected means such that the panel 12 is visible. The touch screen 30 is selectively manipulated to enter events into the calendar and to control the operational parameters of the processor 26. The touch screen 30 displays the monthly calendar and events corresponding to each day of the monthly calendar are displayed on the monthly calendar. The transceiver 32 is selectively networked with other display units 20, personal computers and other electronic devices, via the extrinsic communication network 24, to facilitate the events to be shared among a plurality of users. In this way families and friends may share scheduled events with one another and businesses may share appointments with one another.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic calendar assembly being configured to be mounted on a vertical support surface, said assembly comprising:
a panel being configured to be coupled to a vertical support surface thereby facilitating said panel to be observed, said panel having a height of at least 38.0 cm and a width of at least 30.0 cm wherein said panel is configured to be visible from a distance; and
a display unit being coupled to said panel wherein said display unit is configured to be visible, said display unit selectively displaying indicia, said indicia comprising a monthly calendar including days of week, a name of the month and a grid for each day of the month, each of said grids selectively displaying indicia corresponding to events occurring on each day of the month, said display unit being programmable to display selected indicia corresponding to the events, said display unit being configured to be in electrical communication with an extrinsic communication network thereby facilitating the events to be shared among selected people.

2. The assembly according to claim 1, wherein said display unit comprises:
a processor being positioned within said panel; and
an electronic memory being positioned within said panel, said electronic memory being electrically coupled to said processor, said electronic memory storing data pertaining to the monthly calendar and the events.

3. The assembly according to claim 2, further comprising touch screen being coupled to a first surface of said panel wherein said touch screen is configured to be manipulated, said touch screen being electrically coupled said processor such that said touch screen controls operational parameters of said processor and facilitating data corresponding to the events to be entered into said electronic memory, said touch screen displaying said indicia.

4. The assembly according to claim 2, further comprising a transceiver being positioned within said panel, said transceiver being electrically coupled to said processor, said transceiver being configured to be in wireless electrical communication with the extrinsic communication network thereby facilitating the data corresponding to the events to be shared on the extrinsic communication network.

5. The assembly according to claim 2, further comprising a power supply being coupled to said panel, said power supply being electrically coupled to said processor, said power supply comprising at least one battery.

6. An electronic calendar assembly being configured to be mounted on a vertical support surface, said assembly comprising:
a panel being configured to be coupled to a vertical support surface thereby facilitating said panel to be observed, said panel having a first surface and a second surface, said panel having a height of at least 38.0 cm and a width of at least 30.0 cm wherein said panel is configured to be visible from a distance, said second surface being configured to be coupled to the vertical support surface; and
a display unit being coupled to said panel wherein said display unit is configured to be visible, said display unit selectively displaying indicia, said indicia comprising a monthly calendar including days of week, a name of the month and a grid for each day of the month, each of said grids selectively displaying indicia corresponding to events occurring on each day of the month, said display unit being programmable to display selected indicia corresponding to the events, said display unit being configured to be in electrical communication with an extrinsic communication network thereby facilitating the events to be shared among selected people, said display unit comprising:
a processor being positioned within said panel,
an electronic memory being positioned within said panel, said electronic memory being electrically coupled to said processor, said electronic memory storing data pertaining to the monthly calendar and the events,
a touch screen being coupled to said first surface of said panel wherein said touch screen is configured to be manipulated, said touch screen being electrically coupled said processor such that said touch screen controls operational parameters of said processor and facilitating data corresponding to the events to be entered into said electronic memory, said touch screen displaying said indicia,
a transceiver being positioned within said panel, said transceiver being electrically coupled to said processor, said transceiver being configured to be in wireless electrical communication with the extrinsic communication network thereby facilitating the data corresponding to the events to be shared on the extrinsic communication network, and
a power supply being coupled to said panel, said power supply being electrically coupled to said processor, said power supply comprising at least one battery.
